(19) United States
(12) Patent Application Publication
(10) Pub. No.: US 2026/0127888 A1
(43) Pub. Date: May 7, 2026

(54) INFORMATION GATHERING AND SHARING FROM A COLLISION EVENT

(71) Applicant: GM GLOBAL TECHNOLOGY OPERATIONS LLC, Detroit, MI (US)

(72) Inventors: Mohammad Naserian, Windsor (CA); Daniel Xie, Markham (CA); Patrick Giancarlo Gabriel DiGioacchino, Niagara Falls (CA); Utkarsh Saini, Pickering (CA)

(73) Assignee: GM GLOBAL TECHNOLOGY OPERATIONS LLC, Detroit, MI (US)

(21) Appl. No.: 18/939,722

(22) Filed: Nov. 7, 2024

(51) Int. Cl. G06V 20/54; G06V 10/764; G06V 20/40; H04L 9/08

(52) U.S. Cl. CPC G06V 20/54; G06V 10/764; G06V 20/44; H04L 9/0825; G06V 2201/07

(57) ABSTRACT

A system and method for collecting evidence with an observer device of a collision event of a vehicle on a road are provided. An image sensor captures image data during the collision event. A communication module receives a collision message broadcast from a vehicle involved in the collision event. An evidence collection module processes image data acquired from the image sensor to determine whether the collision event was captured. The evidence collection module also compares temporal and geographic data from the collision message collected by the involved vehicle during the collision event and with time and location metadata in the image data to flag an image of the collision event. An evidence report including the flagged image of the collision event is generated when the time and location metadata matches the temporal and geographic data, and the image data captured the collision event.

### INTRODUCTION

The technical field generally relates to a third-party device gathering evidence of collision event, and more particularly relates to a third-party device detecting a collision between nearby vehicles.

In recent years, advancements in vehicular safety technologies have increasingly focused on improving the ability of vehicles to prevent and mitigate collisions. One significant area of development is in Vehicle-to-Everything (V2X) communication systems, which allow vehicles to exchange critical information in real time with other road users and roadside infrastructure devices. These systems are designed to enhance situational awareness, enabling vehicles to react to potential hazards before they become imminent threats.

A primary use case for V2X communication is the transmission of vehicle data between vehicles. In the event of a minor collision event, the third-party human observers that witness an affected vehicle may not feel that the minor collision is serious enough to stop and that there is no need exists to pull over and share collision event information with other drivers of nearby vehicles.

Despite advancements in traffic management, challenges remain in reducing traffic related to minor vehicle collisions. The present disclosure provides an approach to aid in the exchange of evidence collected by making it quicker, safer, and more dependable for all occupants of the vehicle, thereby addressing the above-mentioned issues and more. Desirable features and characteristics of embodiments herein will become apparent from the subsequent detailed description and the appended claims, taken in conjunction with the accompanying drawings and this introduction.

### SUMMARY

In one aspect, the present disclosure provides a system for collecting evidence of a collision event on a road with an observer device, that is independent from a vehicle involve therein. An image sensor is configured to capture image data of the road during the collision event. The image data includes time and location metadata. A communication module is configured to receive a collision message broadcast from a vehicle involved in the collision event. An evidence collection module is in communication with the image sensor and including a processing unit. The processing unit acquires image data from the image sensor and processes the image data to determine whether the collision event was captured. Temporal and geographic data is acquired from the collision message collected by the involved vehicle during the collision event. The time and location metadata is compared with the temporal and geographic data to coincide the image data with the collision event. An evidence report is generated when (i) the time and location metadata match the temporal and geographic data, and (ii) the image data captured the collision event. The evidence report includes an image of the collision event.

In one embodiment, the image sensor, the communication module, and the evidence collection module may be embodied in a traffic infrastructure platform with the image sensor located proximate to the road for acquiring image data.

In another embodiment, the image sensor, the communication module, and the evidence collection module may be embodied in a witnessing vehicle with the image sensor located proximate to the road for acquiring image data.

In some embodiments, the processing unit described above may be configured to identify the involved vehicle captured in the image data with the collision event. An identified vehicle captured in the image data is classified with the collision event based on a vehicle make, a vehicle model, and a vehicle color. The vehicle make, the vehicle model, and the vehicle color of the identified vehicle is confirmed based on the collision message. The evidence report is transmitted to the involved vehicle when the vehicle make, the vehicle model, and the vehicle color of the identified vehicle are confirmed.

In yet another embodiment, the system described above may include a human machine interface (HMI) in communication with the evidence collection module. The evidence collection module prompts a response input on the HMI from a user to verify when the image data coincides with the collision event.

In one embodiment, the communication module transmits the evidence report in response to a request therefore.

In another embodiment, the evidence report is transmitted to the involved vehicle based on the collision message.

In some embodiments, the processing unit described above may generate an encrypted evidence report with a public key and transmit the encrypted evidence report to the involved vehicle via a communication link.

In yet another embodiment, the processing unit described above may transmit the encrypted evidence report in response to a request received by the communication module from the involved vehicle.

In one embodiment, the system described above may include a human machine interface in communication with the communication module. The communication module receives an acknowledgement from the involved vehicle confirming that the encrypted evidence report was received. The human machine interface displays an indicator acknowledging receipt of the encrypted evidence report by the involved vehicle.

In another aspect, the present disclosure provides a method of collecting evidence of a collision event on a road with an observer device, which is not involved in the collision event. Image data is acquired with an image sensor having a field of view of the road. The image data includes time and location metadata. The image data is processed to determine whether the collision event was captured. A collision message broadcast from a vehicle involved in the collision event on the road is received. The collision message includes temporal and geographic data collected by the involved vehicle during the collision event. The time and location metadata is compared with the temporal and geographic data to coincide the image data with the collision event. An evidence report is generated when (i) the time and location metadata matches the temporal and geographic data, and (ii) the image data captured the collision event. The evidence report includes an image of the collision event.

In one embodiment, the observer device may be a traffic infrastructure platform including the image sensor for acquiring image data, a communication module for receiving the collision message and a collision evidence module for processing the image data and the collision message. The image sensor is located proximate to the road.

In one embodiment, the observer device may be a witnessing vehicle located proximate to the road. The witnessing vehicle includes the image sensor, a communication module for receiving the collision message and a collision evidence module for processing the image data and the collision message.

In one embodiment, the method as described above identifies the involved vehicle captured in the image data with the collision event. An identified vehicle captured in the image data is classified with the collision event based on a vehicle make, a vehicle model, and a vehicle color. The vehicle make, the vehicle model, and the vehicle color of the identified vehicle is confirmed based on the collision message; and transmitting the evidence report to the involved vehicle when the vehicle make, the vehicle model, and the vehicle color of the identified vehicle are confirmed.

In another embodiment, the method as described above prompts a response input from a user to verify when the image data coincides with the collision event.

In yet another embodiment, the method as described above transmits the evidence report in response to a request therefor.

In still another embodiment, the method as described above transmits the evidence report to the involved vehicle based on the collision message.

In one embodiment, the method as described above generates an encrypted evidence report with a public key; and transmitting the encrypted evidence report to the involved vehicle.

In one embodiment, the method receives an acknowledgement from the involved vehicle confirming that the encrypted evidence report was received by the involved vehicle.

In still another aspect, the present disclosure includes method of collecting evidence of a collision event on a road with an observer device, which is not involved in the collision event. Image data is acquired with an image sensor having a field of view of the road. The image data includes time and location metadata. The image data is processed to determine whether the collision event was captured. A collision message broadcast is received from a vehicle involved in the collision event on the road. The collision message includes temporal and geographic data collected by the involved vehicle during the collision event. A collided vehicle captured in the image data is identified with the collision event, and the identified vehicle is classified with the collision event based on a vehicle make, a vehicle model, and a vehicle color; confirming the vehicle make, the vehicle model, and the vehicle color of the identified vehicle based on the collision message. The time and location metadata is compared with the temporal and geographic data to coincide the image data with the collision event. An evidence report is generated when (i) the time and location metadata matches the temporal and geographic data, (ii) the image data captured the collision event and (iii) the vehicle make, the vehicle model, and the vehicle color of the identified vehicle are confirmed. The evidence report, which includes an image of the collision event, is encrypted with a public key and transmitted to the involved vehicle.

### BRIEF DESCRIPTION OF THE DRAWINGS

The exemplary embodiments will hereinafter be described in conjunction with the following drawing figures, wherein like numerals denote like elements, and wherein:

FIG. 1 is an illustrative diagram depicting a third-party observer device in an example environment according to the present disclosure;

FIG. 2 is a block diagram of a collision evidence collection subsystem of a third-party observer device according to the present disclosure; and

FIG. 3 is a flow chart depicting a method of the third-party observer device of FIG. 1 according to the present disclosure.

### DETAILED DESCRIPTION

The following detailed description is merely exemplary in nature and is not intended to limit the application and uses. Furthermore, there is no intention to be bound by any expressed or implied theory presented in the preceding technical field, background, brief summary or the following detailed description. As used herein, the term module refers to an application specific integrated circuit (ASIC), an electronic circuit, a processor (shared, dedicated, or group) and memory that executes one or more software or firmware programs, a combinational logic circuit, and/or other suitable components that provide the described functionality.

Additional information related to the subject matter described and claimed herein are provided in following related applications which are filed by Applicant of even date herewith: System And Method For Collision Matching And Information Exchange (Attorney Docket No. P108567-PRI-NP-US01); Cloud-Based Collision Detection And Information Exchange (Attorney Docket No. P108929-PRI-NP-US01); and A Cloud-Based Platform To Search And Retrieve Collision Related Data (Attorney Docket No. P108926-PRI-NP-US01). The entire disclosures of each of the above applications are incorporated herein by reference.

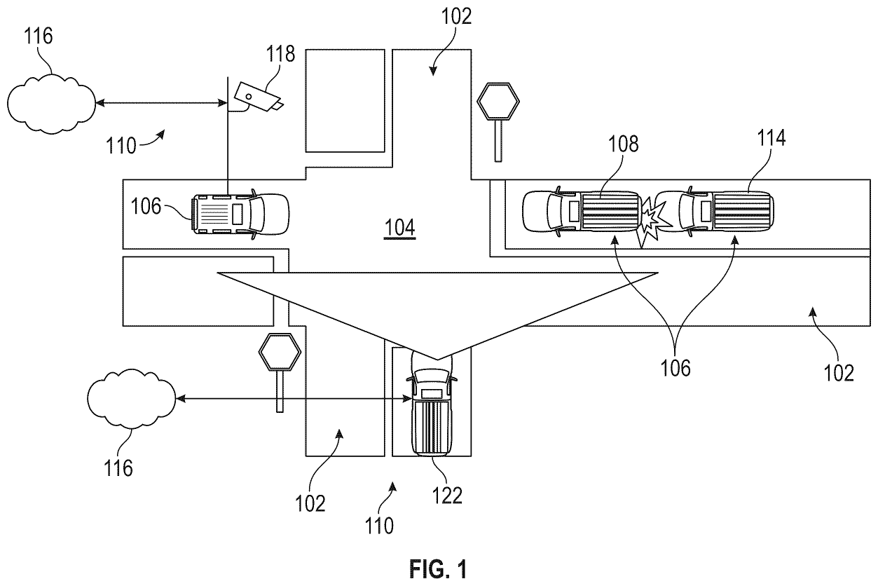

Referring to FIG. 1, the present disclosure provides a system for collecting and sharing collision evidence, namely a collision evidence collection and sharing (CECS) system or simply system 100 located at or proximate to a road 102. For example, the system 100 is located about an intersection 104 of the road 102 and observing one or more vehicles 106. While the system 100 is shown near or about the intersection 104, the system 100 can be positioned at any location where a collision event involving a first, involved vehicle 108 may occur. The system 100 includes an observing device 110 that detects nearby collision events between the involved vehicle 108 and another involved object 112, which in FIG. 1 is a second, involved vehicle 114. While in this example, the involved object 112 is a second, involved vehicle 114, the object 112 could include a pedestrian, a stationary object, a non-motorized vehicle or similar object present along the road 102.

The observing device 110 is the third-party device that is involved, but witnessing or observing the collision event. The observing device 110 is in communication with at least one of a first, involved vehicle 108, a second, involved vehicle 114, a cloud-based platform application or a combination thereof. In one embodiment, the observing device 110 is a traffic infrastructure platform 118 integrated into a distributed roadway or transportation network to aid in managing, monitoring, or enhancing traffic flow, safety or efficiency. The traffic infrastructure platform 118 may include a camera 120, a smart roadside unit (not shown), or a smart traffic light module 121 (not labelled in drawings).

In another embodiment, the observing device 110 is embodied in a witnessing vehicle 122. While FIG. 1 depicts the witnessing vehicle 122 stopped at intersection 104, the witnessing vehicle 122 may be located in any location where a collision event may occur between the first, involved vehicle 108 and the second, involved vehicle 114. For example, the witnessing vehicle 122 may be traveling along the road 102 or parked in a stationary location. These systems can be mechanical, electrical, electronic, hydraulic or a combination of these are designed to ensure that the witnessing vehicle 122 operates and performs effectively under one or more conditions.

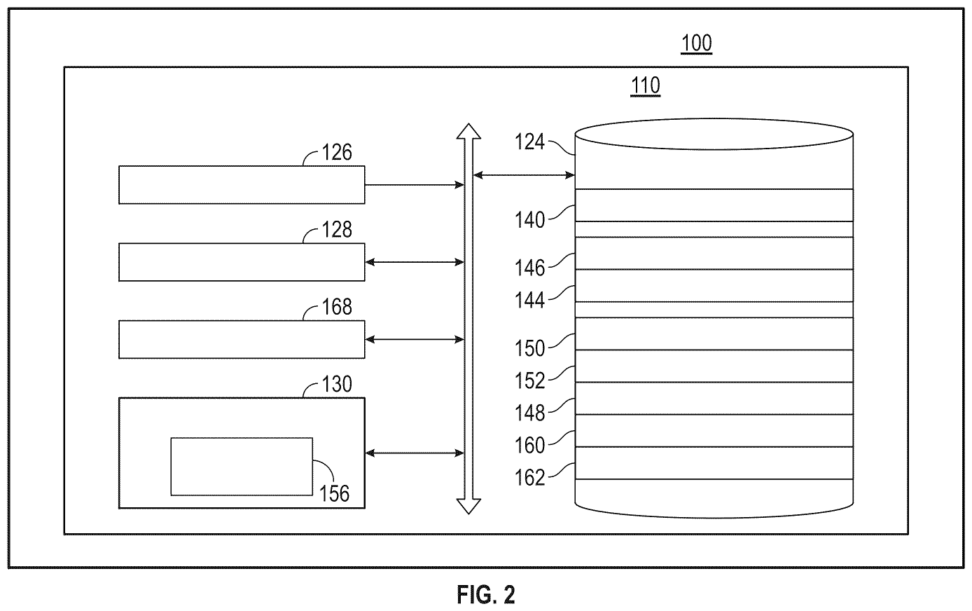

With reference now to FIG. 2, the observing device 110 includes an image sensor 126, a collision evidence module 130, a collision evidence database 124, a communication module 128 and a human machine interface (HMI) 168. The image sensor 126 senses image data 146 capturing a field of view which includes the involved vehicle 108 and the object 112. The image sensor 126 may include a camera, a Lidar sensor, a radar sensor, an ultrasound sensor, or a combination thereof. The image data 146 may include one or more images (i.e., a still image or a video) as well as time and location metadata indicating when and where the image(s) were captured. Depending on the image sensor's field of view, the image data 146 will include the surrounding environment, namely the involved vehicle 108 and the involved object 112, road signs or objects along road 102. The image data 146 may be stored in the collision evidence database 124. The image data 146 may be used to determine whether a collision event occurred between the involved vehicle 108 and the object 112.

The collision evidence module 130 monitors, detects, and responds to collision events. The collision evidence module 130 is in communication with the image sensor 126, the collision evidence database 124, and the communication module 128. The collision evidence module 130 includes a processing unit 156 having a processor (not shown) and a non-transitory storage medium (not shown) with instructions that are executed by the processor. The collision evidence module 130 is configured to detect a collision event involving the involved vehicle 108 and the object 112 and transmit an evidence report 144 to the involved vehicle 108, the object 112, the cloud-based platform application 116 or a combination thereof. For the sake of brevity, the present disclosure provides an example transmitting the evidence report 144 to the involved vehicle 108. However, one skilled in the art could understand that the collision evidence module 130 may transmit the evidence report 144 to a second, involved vehicle 114 and/or upload the evidence report 144 to a cloud-based application without departing from the spirit and scope of the present disclosure.

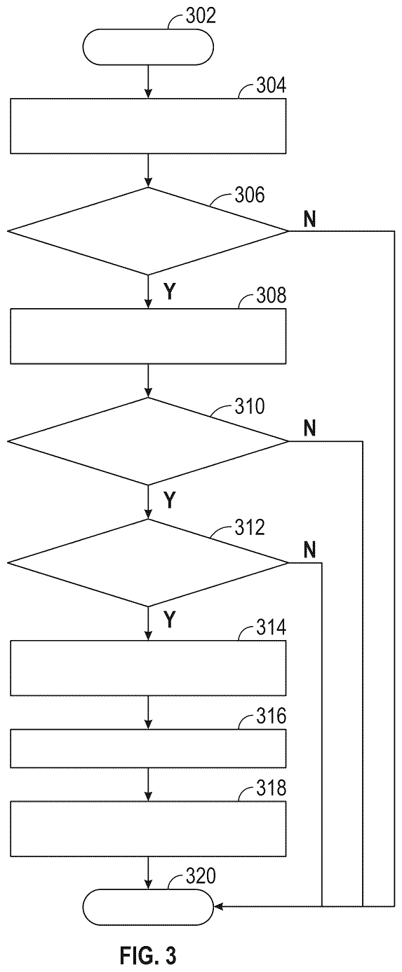

Referring to FIG. 3, the system 100 employes a method 300 to transmit collision evidence report associated with a collision event from the observing device 110, which is initiated at step 302. At step 304, the system 100 acquires image data 146, from the image sensor 126. The image data 146 captures still images and/or video within the field of view. The image data 146 may include a surrounding environment having the first, involved vehicle 108 and the second, involved vehicle 114 moving relative to one another. The system 100 stores the image data 146 in a collision evidence database 124 as recorded image(s) as well as time and location metadata for the image(s). The system 100 proceeds to step 308 and analyzes the acquired image data 146 to detect a collision event between the first and second involved vehicles 108, 114. If the system 100 determines that the collision event was captured in the image data, the method 300 proceeds to step 310. If a collision event was not captured in the image data, the method 300 is returned at step 320.

At step 308, the system 100 receives a collision message broadcasted by an involved vehicle, namely one of the first or second vehicles. The collision message indicates that the involved vehicle has experienced a collision event and includes temporal and geographic data for the collision event. The system 100 processes the collision message to extract the temporal and geographic data and proceeds to step 310.

At step 310, the system 100 compares time and location metadata with the temporal and geographic data to coincide the image data with the collision event. In particular, time and location metadata for image(s) stored in the collision evidence database are compared with the temporal and geographic data from the collision message to flag the image(s) that captured the collision event. If the system 100 flags one or more images of the collision event, the method 300 proceeds to step 312. If the system 100 does not flag any images the method 300 returns at step 320.

At step 312, the system 100 determines whether a request for an evidence report has been made. In one form, the request may be stored and retrieved as a user selected preference from the collision evidence database 124. In another form, the system 100 may prompt a user of the observing device 110, via a human machine interface (HMI) 168, to request transmission of the evidence report. In yet another form, the system 100 is configured to receive a request from a requesting party, such as the involved vehicle. If an evidence report is requested, the evidence collection system proceeds to step 314. If an evidence report is not requested, the method returns at step 320. For the example illustrated in FIG. 3, a request for the evidence report was generated by the involved vehicle 108.

At step 314, the system 100 generates an evidence report including the flagged image(s) of the collision event. The evidence report may also include the time and location metadata, or a combination thereof. The content and format of the evidence report may be stored and retrieved as a report preference from the collision evidence database 124. After the evidence report is generated, the method 300 proceeds to step 316 where the system 100 and the involved vehicle 108 execute a protocol communication handshake to establish a secure connection for the system 100 to communicate with the involved vehicle 108. The system 100 requests a response to confirm that the involved vehicle 108 desires an evidence report for the collision event. After initiating the protocol communication link with the involved vehicle 108, the system 100 encrypts and transmits an encrypted evidence report to the involved vehicle 108 via the communication link at step 318. The system 100 encrypts the evidence report with a public key, which may be decrypted by the involved vehicle 108 using an associated private key. Once the encrypted evidence report has been transmitted, the method returns at step 320.

With reference again to FIG. 2, the collision evidence module 130 may utilize a collision detection model 160 to determine whether the collision event was captured in the image data 146. For example, the collision detection model 160 may be a machine learning model that analyzes the image data 146 to detect whether the involved vehicle experienced a collision event. Based on detecting the collision event, the collision evidence module 130 identifies a plurality of objects in the image data and determines which of the plurality of objects is the involved vehicle using an image processing model 162. The image processing model 162 includes a convolution neural network (CNN) used to analyze the image data to detect the presence of nearby objects. In doing so, the CNN extracts key features such as edges, contours, and textures to differentiate between objects. The collision evidence module 130 identifies a vehicle that may have been involved in a collision with another object (i.e., an involved vehicle). Once an involved vehicle is identified, the collision evidence module 130 may further classify the involved vehicle based on a vehicle make, a vehicle model, and a vehicle color. The collision evidence module 130 may seek confirmation of the vehicle make, vehicle model and vehicle color of the collision related vehicle by prompting a user, via the HMI 168, to image(s) of the involved vehicle based on a display of the vehicle make, vehicle model and vehicle color.

The collision evidence module 130 may also determine whether the collision message 140 was broadcasted by the involved vehicle 108. The collision evidence module 130 may further identify the involved vehicle 108 by comparing the image data of the involved vehicle with the vehicle make, vehicle model and vehicle color provided in the collision message.

The collision evidence database 124 stores and manages data related to operation, performance and history of the system 100. In one example, the collision evidence database 124 is in communication with the communication module 128, the image sensor 126, and the collision evidence module 130. The collision evidence database 124 continuously receives and stores the image data 146 from the image sensor 126. The collision evidence database 124 also stores the collision message 140 broadcasted by the involved vehicle 108. The collision message 140 may be a vehicle-to-vehicle protocol message that is broadcasted by the involved vehicle 108 indicating that it has collided with an object, such as a second, involved vehicle 108. The collision message 140 also includes a location of the collision, a time of the collision, a vehicle identification, a vehicle make, a vehicle model, a vehicle color, and an impact location on the involved vehicle during the collision event. The collision evidence database 124 is also configured to store the evidence report once generated.

In some forms, the collision evidence database 124 manages and stores a plurality of setting/preferences 148 for automatically generating and transmitting an evidence report 144 to the involved vehicle 108. For example, the collision evidence database 124 stores a first user setting set (not shown) related to requesting approval for transmitting the evidence report being set to “YES”, which indicates that the evidence report will be automatically generated and transmitted to the involved vehicle 108. Conversely, the first user setting set (not shown) related to requesting approval for transmitting the evidence report being set to “NO”, which indicates that the evidence report should not be automatically transmitted to the involved vehicle 108. The collision evidence database 124 stores at least one of a public encryption key 150 and a private decryption key 152. The public encryption key 150 is used for securely encrypting the evidence report to be transmitted to the involved vehicle 108. The private encryption key 152 is kept confidential and is used to decrypt encrypted messages received from another V2V vehicle or V2X device. In one form, the collision evidence database 124 includes a plurality of input responses based on selections set by a user of the HMI 168.

The communication module 128 includes a processor (not shown) and a non-transitory computer-readable storage medium (not shown) configured to store instructions that are executed by the processor. The communication module 128 enables exchange of messages between the system 100 and vehicles 106 within a predetermined range. The communication module 128 transmits or broadcasts messages (e.g., data packets containing messages or data) using a dedicated communication protocol, such as a dedicated short-range communication (DSRC), Cellular Vehicle-to-Everything (C-V2X), Vehicle-to-Infrastructure (V2I), Vehicle-to-People (V2P), 5GLTE cellular communication, or the like. The observing device 110 transmits at low latency to ensure that nearby vehicles 106 can quickly receive and process data from the communication module 128 of the system 100. Once a connection is established, the communication module 128 also manages incoming and outgoing data transmission for the observing device 110. The communication module 128 employs asymmetric encryption to secure transmitted or exchanged messages between the observing device and the involved vehicle 108. The communication module 128 receives the collision message 140 sent by the involved vehicle 108. The communication module 128 may also exchange text messages, either automatically or through user input, to convey requests to transmit the evidence report with the involved vehicle 108.

The communication module 128 encrypts the evidence report using the public key. After encryption, the communication module 128 transmits an encrypted evidence report 144 to the involved vehicle 108. The communication module 128 may determine whether a transmitted evidence report was successfully received by the involved vehicle 108. For example, the communication module 128 waits a predetermined time period to determine whether the transmission to the involved vehicle 108 was successful. The communication module 128 may receive an acknowledgement message from the involved vehicle 108 112 indicating that transmission was successful. In this example, the communication module 128 determines that a successful transmission has occurred when the acknowledgment message is received within the predetermined time period. The communication module 128 may display a successful transmission related message to a user of the system 100. The communication module 128 may determine that a successful transmission has not occurred when the acknowledgement message has not been received from the involved vehicle within the predetermined time period. In this example, the communication module 128 may display an unsuccessful transmission related message to a user of the system 100.

The HMI 168 allows a user of the system 100 to interact with the collision evidence module 130 and manage various functions of the system 100. The HMI 168 may include a plurality of user selection inputs that allow a user of the system 100 to respond to one or more prompts. For example, the HMI 168 may display and audibly issue a prompt and/or response to a user of the system 100. In one form, the HMI 168 includes audio system (not shown) and/or a display screen (not shown), such as a touch screen. The audio system may include a speaker and a microphone. The HMI 168 prompts a message on the display to verify that the image data 146 includes a collision event between the involved vehicle 108 and the object 112 identified. The input associated with the user may include a positive response input (“YES”) and a negative response input (“NO”). The positive response input affirms the user's choice to proceed with a selected task. The negative response input negates the user's desire to proceed with the selected task. The HMI 168 may initiate a prompt a message on the display having a user selection input to verify whether the involved vehicle 108 identified in the image data 146 coincides with the vehicle that broadcasted the collision message. The HMI 168 prompts a message displayed on the display to the user and includes a transmission request to transmit the evidence report to the involved vehicle. The HMI 168 may enable an input associated with a texting component to exchange communication, with the involved vehicle, such as alpha numeric text.

While the systems, components and features for a collision event collection and sharing system have been described and illustrated with reference to certain exemplary embodiments. in the foregoing detailed description, it should be appreciated that a vast number of variations exist. It should also be appreciated that the exemplary embodiment or exemplary embodiments are only examples, and are not intended to limit the scope, applicability, or configuration of the disclosure in any way. Likewise, the process of collecting evidence of a collision event on a road with an observer device has been described based on an ordered method of steps. However, it should be appreciated that the sequence of these steps may be modified, revised and/or changed without limiting the scope, applicability, or configuration of the disclosure in any way. Rather, the foregoing detailed description will provide those skilled in the art with a convenient road map for implementing subject matter described and claimed herein. It should be understood that various changes can be made in the function and arrangement of elements without departing from the scope of the disclosure as set forth in the appended claims and the legal equivalents thereof.

1. A system for collecting evidence of a collision event on a road, the system comprising:
an image sensor configured to capture image data of the road during the collision event, wherein the image data includes time and location metadata; and
an observer device in communication with the image sensor, wherein the observer device comprises:
a non-transitory memory storing programming instructions; and
a processor communicatively coupled to the non-transitory memory, wherein the processor executing the programming instructions is configured to:
receive a collision message broadcasted from a first vehicle involved in the collision event, wherein the first vehicle from herein is referred to as an involved vehicle, the observer device is independent and separated from the involved vehicle, and the observer device is one of a second vehicle not involved in the collision event or a traffic infrastructure platform device; and
acquire the image data from the image sensor;
process the image data to determine whether the collision event was captured;
acquire temporal and geographic data from the collision message collected by the involved vehicle during the collision event;
compare the time and location metadata of the image data_with the temporal and geographic data of the collision message when the collision event is captured in the image data to coincide the image data with the collision event; and
generate an evidence report when (i) the time and location metadata match the temporal and geographic data, and (ii) the image data captured the collision event, wherein the evidence report includes an image of the collision event.

2. The system of claim 1, wherein the observer device is the traffic infrastructure platform device the image sensor is located proximate to the road for acquiring image data.

3. The system of claim 1, wherein the observer device is the second vehicle and the image sensor is embodied in the second vehicle.

4. The system of claim 1, wherein the processor executing the programming instructions is further configured to:
identify one or more collided vehicles involved in the collision event in the image data;
classify each collided vehicle in the image data with the collision event based on a vehicle make, a vehicle model, and a vehicle color;
confirm the vehicle make, the vehicle model, and the vehicle color of each collided vehicle classified to determine whether one of the one or more collided vehicles is the involved vehicle that broadcasted the collision message; and
transmit the evidence report to the involved vehicle when the vehicle make, the vehicle model, and the vehicle color of one of the one or more collided vehicles are confirmed.

5. The system of claim 1, wherein the processor executing the programming instructions is further configured to: prompt a response input from a user to verify when the image data coincides with the collision event.

6. The system of claim 1, wherein the processor executing the programming instructions is further configured to transmit the evidence report in response to a request therefor.

7. The system of claim 1, wherein the evidence report is transmitted to the involved vehicle based on the collision message.

8. The system of claim 1, wherein the processor executing the programming instructions is further configured to:
generate an encrypted evidence report with a public key; and
transmit the encrypted evidence report to the involved vehicle via a communication link.

9. The system of claim 8, wherein the processor executing the programming instructions is further configured to transmit the encrypted evidence report in response to a request received from the involved vehicle.

10. The system of claim 9, wherein the processor executing the programming instructions is further configured to:
receive an acknowledgement from the involved vehicle confirming that the encrypted evidence report was received; and
display an indicator acknowledging receipt of the encrypted evidence report by the involved vehicle.

11. A method of collecting evidence of a collision event on a road using an observer device, the method comprising:
acquiring, a processor, image data with an image sensor having a field of view of the road, wherein the image data includes time and location metadata;
receiving, using the processor, a collision message broadcasted, in the observer device, from a first vehicle involved in the collision event on the road, wherein the first vehicle from herein is referred to as an involved vehicle, the collision message indicates that the involved vehicle has experienced the collision event and includes temporal and geographic data collected by the involved vehicle during the collision event, wherein the observer device is independent and separated from the involved vehicle and the observer device is one of a second vehicle or a traffic infrastructure platform device;
processing, using the processor, the image data to determine whether the collision event was captured when the collision message is received;
comparing, using the processor, the time and location metadata of the image data with the temporal and geographic data of the collision message when the collision event is captured in the image data to coincide the image data with the collision event; and
generating, using the processor, an evidence report when (i) the time and location metadata matches the temporal and geographic data, and (ii) the image data captured the collision event, wherein the evidence report includes an image of the collision event.

12. The method of claim 11, wherein the observer device comprises the traffic infrastructure platform device communication module for and wherein the image sensor is located proximate to the road.

13. The method of claim 11, wherein the observer device comprises the second vehicle located proximate to the road, and the second vehicle includes the image sensor.

14. The method of claim 11, further comprises:
identifying one or more collided vehicles involved in the collision event in the image data;
classifying each collided vehicle captured in the image data with the collision event based on a vehicle make, a vehicle model, and a vehicle color;
confirming the vehicle make, the vehicle model, and the vehicle color of each classified vehicle to determine whether one of the one or more collided vehicles is the involved vehicle that broadcasted the collision message; and
transmitting the evidence report to the involved vehicle when the vehicle make, the vehicle model, and the vehicle color of one of the one or more collided vehicles is confirmed.

15. The method of claim 11 further comprising prompting a response input from a user to verify when the image data coincides with the collision event.

16. The method of claim 11 further comprising transmitting the evidence report in response to a request therefor.

17. The method of claim 11 further comprising transmitting the evidence report to the involved vehicle based on the collision message.

18. The method of claim 11 further comprising:
generating an encrypted evidence report with a public key; and
transmitting the encrypted evidence report to the involved vehicle.

19. The method of claim 18 further comprising receiving an acknowledgement from the involved vehicle confirming that the encrypted evidence report was received by the involved vehicle.

20. A method of collecting evidence of a collision event on a road with an observer device, the method comprising:
acquiring image data with an image sensor having a field of view of the road, wherein the image data includes time and location metadata;
receiving, using a processor of the observer device, a collision message broadcasted from a first vehicle involved in the collision event on the road, wherein the first vehicle is referred to as an involved vehicle from herein, wherein the collision message indicates that the involved vehicle has experienced the collision event and includes temporal and geographic data collected by the involved vehicle during the collision event, wherein the observer device is independent and separate from the involved vehicle, and wherein the observer device is one of a second vehicle or a traffic infrastructure platform device;
processing, using the processor, the image data to determine whether the collision event was captured when the collision message is received;
identifying, using the processor, one or more collided vehicles vehicle involved in the collision event that were captured in the image data;
classifying, using the processor, each collided vehicle identified in the image data based on a vehicle make, a vehicle model, and a vehicle color;
confirming, using the processor, the vehicle make, the vehicle model, and the vehicle color of each collided vehicle classified to determine whether one of the one or more collided vehicles is the involved vehicle that broadcasted the collision message;
comparing, using the processor, the time and location metadata with the temporal and geographic data to coincide the image data with the collision event;
generating, using the processor, an evidence report when (i) the time and location metadata matches the temporal and geographic data, (ii) the image data captured the collision event and (iii) the vehicle make, the vehicle model, and the vehicle color of one of the one or more collided vehicles are confirmed, wherein the evidence report includes an image of the collision event;
encrypting, using the processor, the evidence report with a public key; and
transmitting, using the processor, an encrypted evidence report to the involved vehicle.
